(19) United States
(12) Patent Application Publication
(10) Pub. No.: US 2006/0170684 A1
(43) Pub. Date: Aug. 3, 2006

(54) Font cache and meta-fonts

(75) Inventors: Hiroki Kobayashi, Seattle, WA (US); Kazuyuki Shibuya, Bellevue, WA (US)

Correspondence Address: PERKINS COIE LLP/MSFT, P. O. BOX 1247, SEATTLE, WA, 98111-1247, US

(73) Assignee: Microsoft Corporation, Seattle, WA (US)

(21) Appl. No.: 11/046,575

(22) Filed: Jan. 28, 2005

(51) Int. Cl. G06T 11/00

(52) U.S. Cl. 345/467

(57) ABSTRACT

Methods and systems for managing the access and display of characters from one or more fonts may include initializing a storage space (e.g., a font cache) in a computer memory. The storage space may store information for select characters from the one or more fonts, allowing easy access by a font management routine. In the meantime, a second storage space (e.g., hard disk or DVD) stores information relating to all the characters from one or more fonts, which may be contained in one or more files. The font management routine receives an indication of a desired character to be rendered and determines whether the desired character is currently stored in the first storage space, the font management routine (or a related routine) may load the desired character from the second storage space into the first storage space.

### BACKGROUND

Advances in computer graphics allow for the display of three-dimensional graphical objects (e.g., characters in a video game) in a two-dimensional space (e.g., a computer screen or monitor). Video games and other applications that use three-dimensional graphics appear very lifelike to a user, and add to the user's enjoyment of the experience. One technique for generating three-dimensional graphics includes the use of textures. A texture is a two-dimensional bitmap typically used to simulate real world texture detail (e.g., wood, grain, carpet, etc.) when drawing otherwise flat geometry in a three-dimensional rendering of a scene. In some cases, the texture is made up of multiple two-dimensional pixels. Each pixel has the properties of position, color, brightness, and depth. Once created, the texture can be used for rendering images of many types, including images representing text or symbols. Using textures for rendering two-dimensional text is generally desirable over other text-rendering techniques because textures allow the text to be easily projected, scaled, and rotated as appropriate.

Textures used in font rendering can often be very large. For example, because video games do not market well unless they are visually impressive, it is often desirable to have multiple attractive fonts used in one scene. Accordingly, a single texture used in text rendering for a three-dimensional video game may include a large set of characters (e.g., the text characters, symbols, and/or images that go along with a certain font or text style). The textures used for font rendering in video games for international markets may also be quite large. For example, a game including Chinese text may require around 5000-8000 characters. If each character were pre-rendered into a 20×20 pixel section of a texture bitmap, then the entire texture bitmap would be 1800×1800 pixels, or 3.25 MPixels.

Text rendering from a texture typically involves selecting a set of texture coordinates that match where a desired glyph resides in the texture (e.g., the coordinates that make up the letter “G”). For example, one method for text rendering from a texture involves storing the font as a bitmapped texture (e.g., a font bitmap) and rendering individual characters as screen-space aligned quads. This technique uses native functionality of a graphics processing unit (GPU) or similar hardware to render bitmap-based fonts at a full fill rate (measured in pixels per second) of the hardware associated with the GPU. One limitation of this technique is that, when employed with large character sets (e.g., the Unicode character set), it may require texture sizes that exceed current hardware capabilities and use large amounts of memory. In addition, it is very difficult to predict how much memory the game should set aside for a font bitmap before the translation of the texts occurs. Moreover, the font bitmaps may be updated when new fonts are available as downloadable contents, resulting in further memory allocation problems, and other issues.

### SUMMARY

Methods and systems for rendering text including text characters, symbols, and other characters, are described herein. In some embodiments, the methods and systems may be implemented, at least in part, via a font management routine of a software application (e.g., video game). The font management routine may read individual characters from one or more font files that may be stored, at least temporarily, on a hard disk, DVD, or other medium that the font management routine may access as needed.

In some embodiments, the font management routine may copy or load the read characters into a font cache system (which may, for example, be created as an instance at application initialization). The font management routine may also load metadata and/or other information associated with the read characters (e.g., character width, offset, placement information, etc.) into the font cache system. Accordingly, the font cache system may include a cache (e.g., to store the characters themselves) and a table, or other data structure, that stores the metadata and/or other information associated with the characters.

In some cases, the cache of the font cache system is a predetermined size that is smaller than the total number of available characters in the font file. Accordingly, the table may store information relating to the status (e.g., information about whether the character is presently in the cache, etc.). The table (or in some cases, a separate priority queue) may store information relating to how recently a character stored in the cache was used. In this way, when the cache becomes full, the font cache system may rely on status information in the table and/or the priority queue to purge the least recently used characters from the font cache.

In some embodiments, the methods and systems for rendering three-dimensional graphics, including text, may also include the use of meta-fonts that combine more than one font type into a single rendering scheme. For example, any given meta-font may include two or more sets of fonts in a single arrangement, (e.g., a single font file containing both Western European characters and East Asian characters). Like the font files described above, the meta-font may be stored on a hard drive, DVD, or other persistent storage medium and then accessed by the font management routine.

In some embodiments, the font management routine (or another routine) checks each character of an input string to be rendered to determine which characters of the meta-font should be used (e.g., East Asian font vs. European font). Where a font cache system is being used to implement the meta-font, if the appropriate characters of the meta-font are not currently stored in the cache, the font management routine may fetch them as needed from the persistent storage so that the string can be displayed.

### BRIEF DESCRIPTION OF THE DRAWINGS

FIG. 1 is a block diagram showing an example of an environment in which the invention may be implemented in one embodiment.

FIG. 2 is a block diagram showing the flow of data through components of the representative environment of FIG. 1 in one embodiment.

FIG. 3 is a data diagram showing an example of characters stored in a cache over a course of events in one embodiment.

FIG. 4 is a flow diagram showing an example of a font management routine being performed at a game application.

FIG. 5 is a block diagram showing an example of meta-fonts, each consisting of two or more fonts.

FIG. 6 is a data diagram showing an example of a single entity meta-font from the perspective of a font management routine in one embodiment.

FIG. 7 is a data diagram showing an example of the contents of a meta-font initialization file in one embodiment.

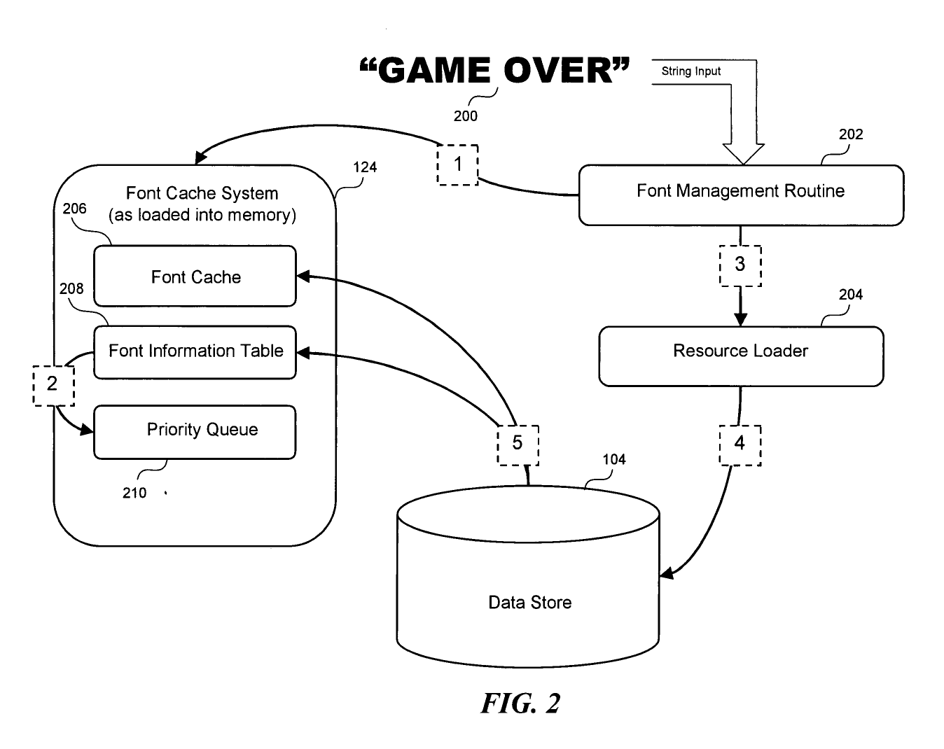

In the drawings, the same reference numbers identify identical or substantially similar elements or acts. To facilitate the discussion of any particular element or act, the most significant digit or digits in a reference number refer to the figure number in which that element is first introduced (e.g., element 204 is first introduced and discussed with respect to FIG. 2).

A portion of this disclosure contains material to which a claim for copyright is made. The copyright owner has no objection to the facsimile reproduction by appears in the Patent and Trademark Office patent file or records, but reserves all other copyright rights whatsoever.

A portion of this disclosure contains material to which a claim for copyright is made. The copyright owner has no objection to the facsimile reproduction by anyone of the patent document or patent disclosure (including Figures), as it appears in the Patent and Trademark Office patent file or records, but reserves all other copyright rights whatsoever.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

It is intended that the terminology used in the description presented be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

I. Representative System

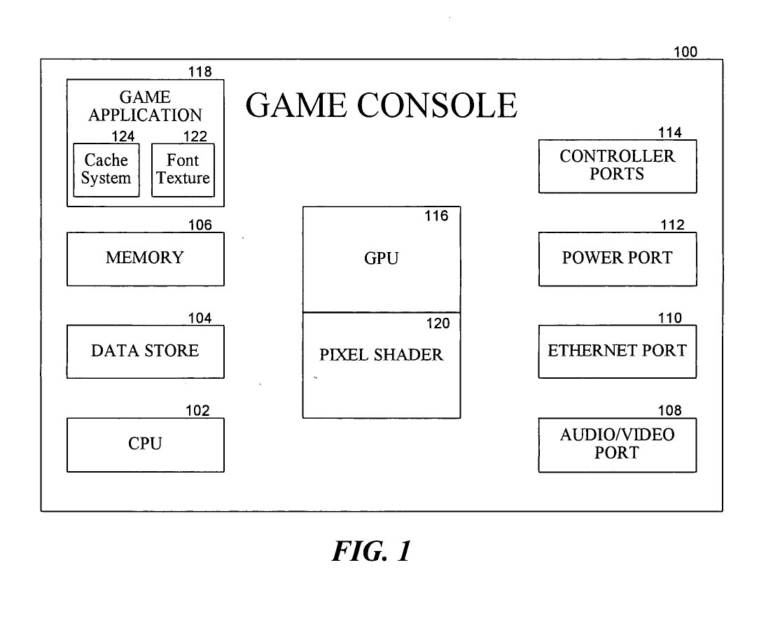

FIG. 1 and the following discussion provide a brief, general description of a representative environment in which the invention can be implemented. Although not required, aspects of the invention are described in the general context of computer-executable instructions, such as routines executed by a general-purpose computer (e.g., a server computer, wireless device, or personal/laptop computer). Those skilled in the relevant art will appreciate that the invention can be practiced with other communications, data processing, or computer system configurations, including game consoles, Internet appliances, hand-held devices (including personal digital assistants (PDAs)), wearable computers, all manner of cellular or mobile phones, embedded computers (including those coupled to vehicles), multi-processor systems, microprocessor-based or programmable consumer electronics, set-top boxes, network PCs, minicomputers, mainframe computers, and the like. Indeed, the term “computer,” generally refers to any of the above devices and systems, as well as any data processor.

Aspects of the invention can be embodied in a special-purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communication network. In a distributed computing environment, program modules may be located in both local and remote memory storage devices.

Aspects of the invention may be stored or distributed on computer-readable media, including magnetically or optically readable computer disks, as microcode on semiconductor memory, nanotechnology memory, organic or optical memory, or other portable data storage media. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or may be provided on any analog or digital network (packet-switched, circuit-switched, or other scheme). Those skilled in the relevant art will recognize that portions of the invention reside on a server computer, while corresponding portions reside on a client computer, such as a mobile device.

Referring to FIG. 1, the representative environment in which the methods and systems for rendering three-dimensional graphics, including text, can be practiced includes a game console 100. The game console 100 may include a CPU 102, a data store 104 (e.g., hard disk or DVD), a memory 106, an audio/video port 108, an Ethernet port 110, a power port 112, and one or more controller ports 114. In addition, the game console 100 may include a graphics processing unit (GPU), component 116, which may include a pixel shader 120.

In some embodiments, the GPU component 116 processes graphics provided by a game application 118 that runs on the game console 100. While running on the game console 100, the parts of the game application (e.g., a font caching system 124) may be stored in memory 106, while other parts of the game application (e.g., a font texture 122 or font file) may be stored (at least temporarily) in the data store 104.

II. System Flows

FIG. 2 is a block diagram showing the flow of data through components of the representative environment of FIG. 1. In some embodiments, the flow of data may be managed by a font management routine 202. Although it may be described herein as single routine for purposes of clarity, the font management routine 202 may, in fact, be comprised of one or more functions, routines, or subroutines that interact with various aspects of hardware and software in a computer system. An example of such a subroutine is a resource loader routine 204 that processes loading requests made by the font management routine. For example, the resource loader routine 204 may load information from the data store 104 to the font cache system 124 (both previously illustrated with respect to FIG. 1). The font cache system 124 is shown in more detail, and may include a cache component 206 that holds character bitmap information (e.g., in uniform grid fashion). In some embodiments using a grid-style cache, the size of the cache may be determined as follows: Cache size=(Cache Width/Cell size)*(Cache Height/Cell size). The font cache system may also include a font information component 208 that holds metadata about the characters (e.g., texture coordinates, ABC width of characters in the bitmap, etc.) and a priority queue component that controls the order of characters removed from the cache upon cache overflow.

In the illustrated example, the font management routine 202 receives an input parameter consisting of a “GAME OVER” string 200. At block 1, the font management routine 202 checks each character in the “GAME OVER” string 200 to determine if it is currently stored in the cache 206. If a character of the “GAME OVER” string is currently stored in the cache 206, at block 2, the font management routine 202 facilitates updating the priority queue 210 so that the character is marked as the most recently used. If a character of the “GAME OVER” string is not currently stored in the cache 206, at block 3, the font management routine 202 issues a loading request to the resource loader routine 204. At block 4, the resource loader routine 204 processes the loading requests and may call one or more associated functions to help perform this processing. For example in the case of a game application, actual loading may be implemented asynchronously by the game application itself. At block 5, the resource loader routine 204 (or associated functions) loads bitmap information into the cache 206 for the desired character and loads metadata about the character into the font information table 208. The order of loading bitmap information and metadata information may vary from embodiment to embodiment (e.g., metadata first, bitmap information first, concurrent loading, random loading, etc.).

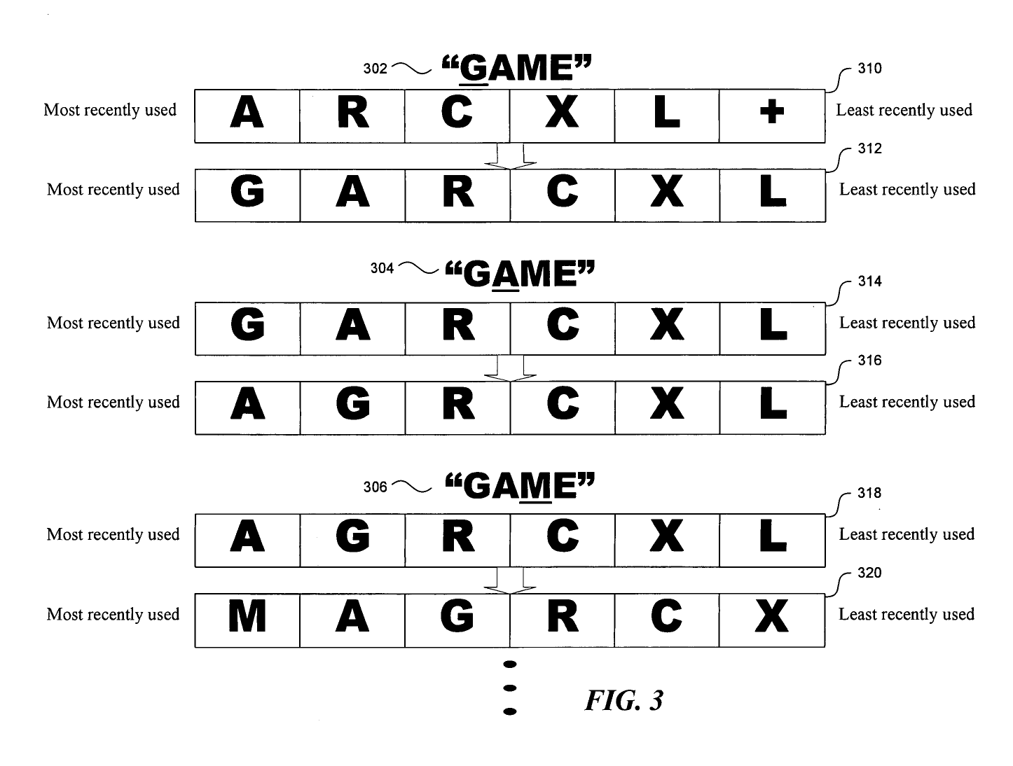

FIG. 3 shows an example of characters stored in a cache (such as the cache 206 of FIG. 2) at various points (310, 312, 314, 316, 318, and 320) during a sequence of activities associated with insuring that characters from a “GAME” string are all loaded into the cache. At point 310, the characters “A,” “R,” “C,” “X,” “L,” and “+,” are currently loaded into the cache. While they are shown as being ordered from most recently used to least recently used, the ordering of the characters in the cache may be managed using any one of a number of techniques, including the use of a separate priority queue, as described with respect to FIG. 2. After a determination that a character “G” 302 from the “GAME” string is currently not in the cache, as shown at point 312, the character “G” is loaded into the cache, and the character “+” is removed.

At point 314, the characters “G,” “A,” “R,” “C,” “X,” and “L” are currently loaded into the cache, with the character “G” shown as the most recently used character. After a determination that a character “A” 304 from the “GAME” string is currently in the cache, as shown at point 316, the cache remains unchanged.

At point 318, the characters “G,” “A,” “R,” “C,” “X,” and “L” are currently loaded into the cache, with the character “G” still shown as the most recently used character. After a determination that a character “M” 306 from the “GAME” string is currently in not in the cache, as shown at point 320, the character “G” is loaded into the cache, and the character “L” is removed, leaving “M” as the most recently used character and “X” as the least recently used character. This process may continue until all the appropriate characters have been loaded into the cache. In some embodiments, a rendering routine renders characters as they are loaded into the cache. In other embodiments, the rendering routine waits to perform rendering until all the characters from a string are loaded into the cache. In some embodiments, while character-by-character rendering may not be as fast as sting-by-string rendering, character-by-character rendering may allows for character-specific manipulations, such as rotating a character about x, y, and t-axes.

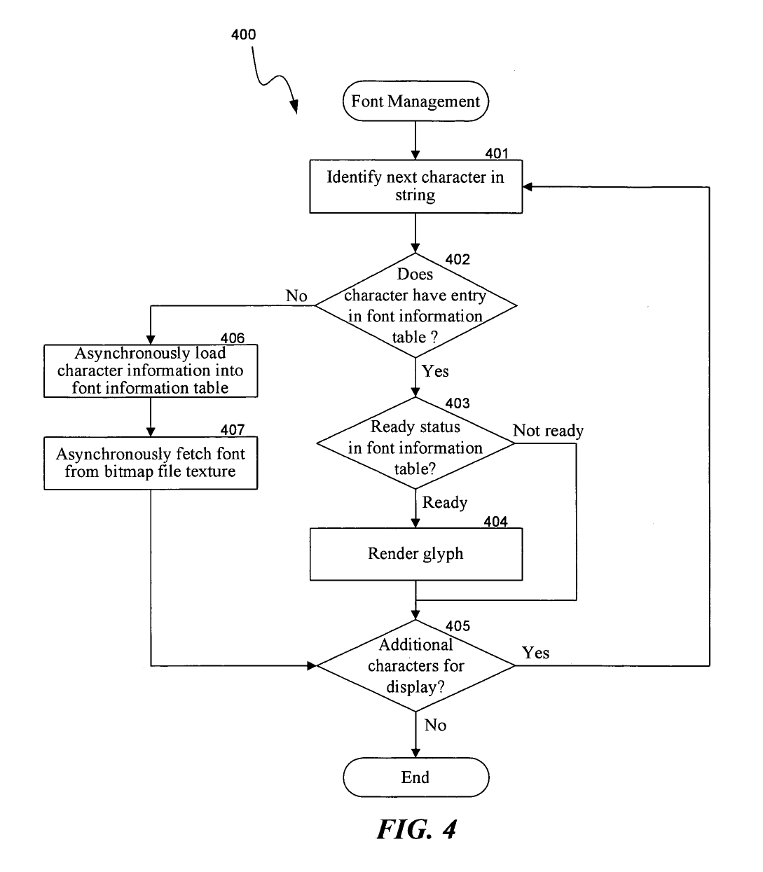

FIG. 4 is a flow diagram showing an example of a font management routine 400 being performed at a game application. Prior to the performance of this routine 400, the game application instantiates a font caching system including a cache and a font information table. In addition, the font caching system receives an input comprised of a string of characters to be rendered in a video game display (e.g., a “Select Players” string). At block 401, the routine 400 identifies the next character in the string. At decision block 402, the routine 400 determines whether there is an entry for the identified character in the font information table. If at decision block 402, the routine 400 determines that the character does not have an entry in the font information table, then it is clear that the bitmap information for the character is not currently stored in the cache. Accordingly the routine 400 continues at block 406, where the routine 400 fetches the character from the texture for loading into the cache, and at block 407, where the routine 400 loads metadata associated with the fetched character into the font information table.

If, however, at decision block 402, the routine 400 determines that the character already has an entry in the font information table, then the routine 400 proceeds to decision block 403, where the routine 400 checks the status of the character as indicated in the font information table. If the status of the character as indicated in the font information table is READY, then the character is currently in the cache, and the routine 400 may proceed to block 404 to render the glyph. If however, at decision block 403, the status of the character as indicated in the font information table is NOT READY, then there is an error and the routine 400 ends.

At decision block 405, the routine 400 determines whether there are additional characters in the input string to be fetched and/or rendered. If so, the routine 400 loops back to block 401 to identify the next character in the string. If there are no additional characters in the input string to be fetched and/or rendered, then the routine 400 ends.

In some embodiments, a font management routine, such as the font management routine 400 of FIG. 4, may employ various techniques to speed up rendering and/or to reduce memory usage. For example, to speed up rendering, the font management routine may use functionality that reduces the number of new vertex buffers that the application creates during run time. In one implementation, the font management routine may use functionality configured to copy each string from the application and maintain it in a class so that the vertex buffer is only deleted and recreated when the game destroys the instance of this string via the class or when the string is updated via the class (and not every time the rendered text is moved on the screen as a result of scrolling or other dynamic action). In contrast, reducing memory usage may involve implementing techniques that write vertex data for the text directly to a new vertex buffer at every frame. In this way, the application does not have to keep track of the string memory or the vertex buffer memory from frame to frame.

III. Meta-Fonts

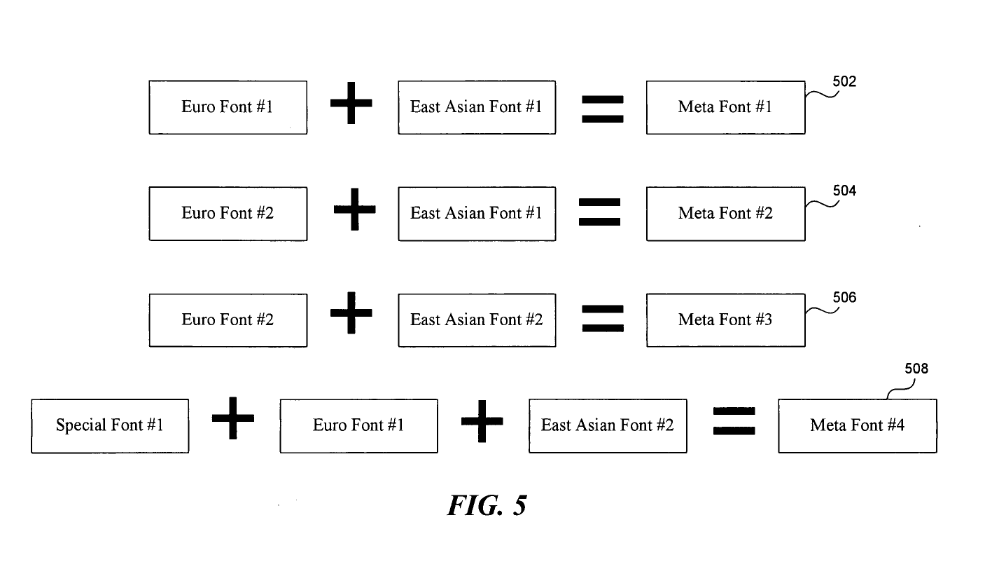

In some embodiments, the methods and systems for rendering three dimensional graphics, including text, may also include the use of meta-fonts that combine more than one font type into a single entity (e.g., a single virtual font bitmap). For example, as shown in FIG. 5, any given meta-font (502, 504, 506, or 508) may include two or more sets of fonts in a single arrangement, (e.g., a single font file containing both Western European characters and East Asian characters).

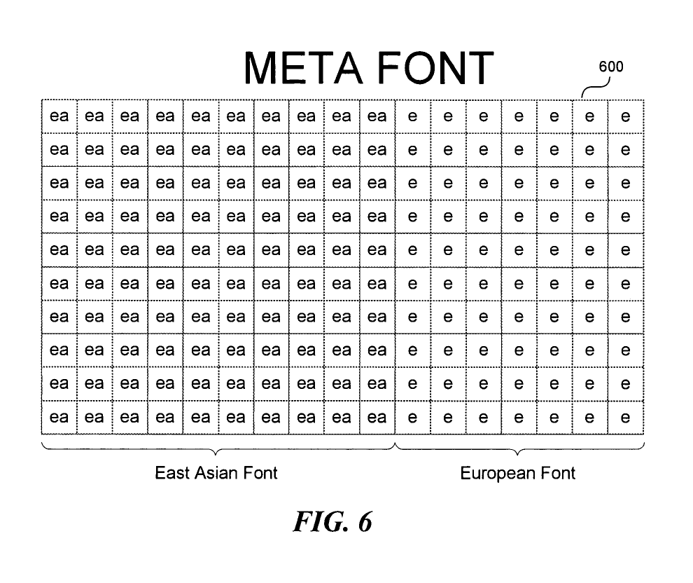

While the meta-font may actually be comprised of multiple separate fonts, in some embodiments, it appears as a single entity 600 to the font management routine, as shown in FIG. 6. In this way, the meta-font can be used like any other font. For example, like the font files accessed by the file management routine described above, the files defining the meta-font may be stored on a hard drive, DVD, or other persistent storage medium and then accessed by the font management routine. For example, to render font output, the font management routine (or another routine) checks each character of an input string to determine which characters of the meta-font should be used (e.g., East Asian font vs. European font). Where a font cache system is being used to implement the meta-font, if the appropriate characters of the meta-font are not currently stored in the cache the font management routine may fetch them as needed from the hard disk or other persistent storage so that all the characters of the string can be displayed and rendered. For example, to determine whether a given font is in the cache, the font management routine may consider the character Unicode as well as an appropriate meta-font ID.

In some embodiments, certain techniques may be used to smooth out differences between the one or more fonts comprising the meta-font. For example, European fonts are often designed with “internal leading,” meaning that there is a space on top of each character (i.e., where an accent symbols may be displayed) while fonts from languages that do not have accent symbols do not have this space. Similar inconsistencies may exist and vary from language to language (e.g., different heights, widths, and spacing of characters). To make up for these types of inconsistencies between the characters in different languages, the meta-font may use different sizes and styles of script for the characters of each language in the meta-font. For example, a bitmap for a meta-font that includes both European and East Asian characters may use European characters drawn using Arial-24 and East Asian characters drawn using MS Gothic-20. Another example of compensating for such differences is to add a localizable offset value to force the East Asian characters to appear lower.

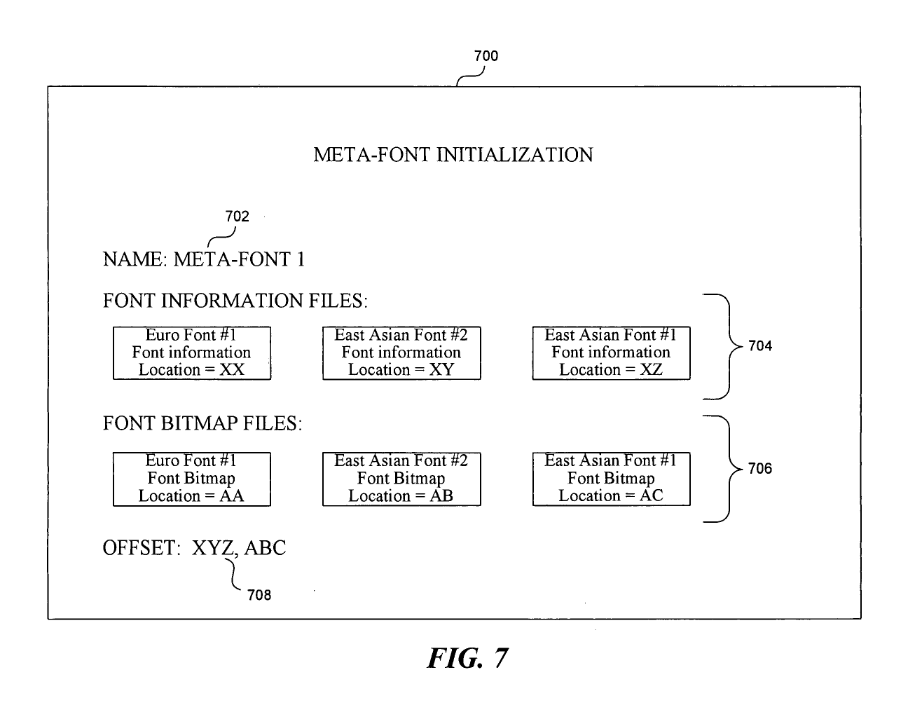

In some embodiments, the meta-font is implemented using an initialization routine that may operate based on information in a meta-font initialization file 700, as illustrated in FIG. 7. For example, the initialization file may include a name 702 (or another identifier) of the meta-font as well as a first set of location information 704 relating to one or more files containing metadata about each of the different font languages (e.g., a first file path for a European font information file and a second file path for an East Asian font information file). The initialization file may also include a second set of location information 706 relating to one or more files containing bitmap data about each of the different font languages (e.g., a first file path for a European font bitmap file and a second file path for an East Asian font bitmap file). The initialization file may also include offset information 708 to be applied to one or more fonts of the meta-font (e.g., the number of pixels that East Asian characters will be displayed from the top of the font). The effect of this configuration is a type of virtual font bitmap and font information file that the game application can treat as a single entity, as shown in FIG. 6.

Because the initialization file can be modified to reference different fonts, a an application designer may more easily modify the fonts used in the application by simply changing the initialization file so that they identify new font information files and font bitmap files for desired fonts. In this way, the designer can modify or add new fonts from multiple languages without having to change other fonts used in the application.

IV. Conclusion

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in the above Detailed Description using the singular or plural number may also include the plural or singular number, respectively.

The teachings of the invention provided herein can be applied to other systems, not necessarily the system described herein. The elements and acts of the various embodiments described above can be combined to provide further embodiments. For example, the techniques described above may be combined with other techniques for improving memory usage issues, such as font packing techniques described in the following commonly owned U.S. patent applications: U.S. patent application Ser. No. 10/979,962 (attorney docket no. 418268090US00) filed Nov. 2, 2004, and entitled “Texture-based Packing, such as for Packing 16-bit Pixels into Four Bits;” U.S. patent application Ser. No. 10/979,963 (attorney docket no. 418268090US01) filed Nov. 2, 2004, and entitled “Texture-based Packing, such as for Packing 8-bit Pixels into Two Bits;” and U.S. patent application Ser. No. 10/980,404 (attorney docket no. 418268090US02) filed Nov. 2, 2004, and entitled “Texture-based Packing, such as for Packing 8-bit Pixels into One Bit,” which are all herein incorporated by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A method in a computer for managing the access and display of characters associated with an application causing the display of the characters, wherein the characters are arranged into at least one font group, the method comprising:
initializing a first storage space in a memory of the computer, wherein the first storage space includes storage for information for a predetermined number of characters included in the at least one font group;
storing information associated with the at least one font group in a second storage space associated with the computer, wherein the second storage space is distinct from the memory of the computer, and wherein the second storage space stores information for all the characters included in the at least one font group;
receiving an indication of a character to be rendered from the at least one font group;
determining whether the character to be rendered is currently stored in the first storage space; and
if the character to be rendered is not currently stored in the first storage space, loading the character to be rendered into the first storage space.

2. The method of claim 1
wherein the application is a game application,
wherein the character to be rendered is displayed by the application as a three-dimensional character in a two-dimensional space,
wherein information associated with the at least one font group, as stored in the second storage space, includes at least one font bitmap file and at least one font information file that stores metadata relating to the characters of the at least one font group,
wherein first storage space includes a font cache and a font information table,
wherein the font cache stores bitmap information for at least one character, wherein the bitmap information for the at least one character is obtained from the at least one font bitmap file,
wherein the font information table stores metadata relating to the at least one character,
wherein the metadata for the at least one character is obtained from the at least one font information file, and
wherein the bitmap information and the metadata for the at least one character, as stored in the first memory, is used in rendering the at least one character.

3. The method of claim 1
wherein information associated with the at least one font group, as stored in the second storage space, includes:
a first font bitmap file relating to a first font,
a second font bitmap file relating to a second font,
a first font information file relating to the first font,
a second font information file relating the second font;
wherein first storage space includes a font cache and a font information table;
wherein the font cache stores bitmap information for at least one character; and
wherein the font information table stores metadata relating to the at least one character.

4. The method of claim 1 wherein the at least one font group includes a meta-font comprised of two or more fonts that are accessed by the application from the first storage space as a single font entity.

5. The method of claim 1 wherein first storage space includes a font cache and a font information table, wherein the font cache stores bitmap information for some of the characters in the at least one font group, wherein the font information table stores metadata relating to some of the characters in the at least one font group, and wherein determining whether the character to be rendered is currently stored in the first storage space includes:
determining whether the character to be rendered currently has a corresponding entry in the font information table; and
if the character to be rendered currently has a corresponding entry in the font information table, determining the status of the corresponding entry.

6. The method of claim 1 wherein first storage space includes a font cache and a font information table, wherein the font cache stores bitmap information for some of the characters in the at least one font group, wherein the font information table stores metadata relating to some of the characters in the at least one font group, and wherein determining whether the character to be rendered is currently stored in the first storage space includes:
loading bitmap information associated with the character into the font cache; and
loading metadata associated with the character into the font information table.

7. The method of claim 1, further comprising removing information for a previously rendered character from the first storage area before loading the at least one character so that the predetermined number of characters is not exceeded.

8. The method of claim 1
wherein the information for all the characters included in the font as stored in the second storage space includes at least one font bitmap file and at least one font information file that stores metadata relating the characters in the at least one font group, and
wherein first storage space includes a font cache, a font information table, and a priority queue.

9. The method of claim 1 wherein the at least one font group includes a meta-font comprised of two or more fonts that are accessed by the application from the first storage space as a single font entity, wherein a first one of the two or more fonts includes characters that are offset during rendering to maintain consistency in appearance with characters of a second one of the two or more fonts.

10. A system for managing an application's access to character information used in representing text, wherein the character information defines characters organized into one or more fonts, the system comprising:
a storage medium that is at least indirectly accessible by the application, wherein the storage medium stores information for all the characters of one or more fonts;
a font cache system for storing information for a predetermined number of characters of the one or more fonts, wherein the font cache system is configured to enable the application to access information from the font cache system more quickly than it accesses information from the storage medium; and
a font management component configured for managing the contents of the font cache system, including loading character information from the first storage medium to the font cache system when character information for a character to be rendered is not currently stored in the font cache system.

11. The system of claim 10 wherein the storage medium includes space on a hard disk associated with the computer on which the application is running.

12. The system of claim 10 wherein the first storage medium includes space on a removable disk associated with a computer on which the application is running.

13. The system of claim 10 wherein the font cache system is created as an instance when the application is initialized.

14. The system of claim 10 wherein the font cache system includes a cache that stores bitmap information for a predetermined number of characters from the one or more fonts.

15. The system of claim 10 wherein the font cache system includes a font information entity that stores metadata related to select characters of the one or more fonts.

16. The system of claim 10 wherein the font cache system includes a font information entity that stores offset data related to select characters of the one or more fonts.

17. The system of claim 10 wherein the font cache system includes:
a cache configured to store bitmap data relating to select characters of the one or more fonts;
a font information entity that stores offset data related to select characters of the one or more fonts; and
a priority queue to manage the order that character information is added and removed from the font cache system.

18. The system of claim 10 wherein the font cache system includes a font information entity that stores status information relating to whether select characters are accessible from the font cache.

19. A computer-readable medium containing instructions for performing a method comprising:
initializing a cache entity in a memory of a computer, wherein the cache entity stores information for a predetermined number of characters included in one or more fonts;
storing information associated with the one or more fonts in a storage space associated with the computer, wherein the storage space is separate from the memory of the computer, and wherein the storage space stores information for all the characters included in the one or more fonts;
receiving an indication of a character to be rendered from the one or more fonts;
determining whether the character to be rendered is currently stored in the cache entity; and
if the character to be rendered is not currently stored in the cache entity, loading the character to be rendered into the cache entity.

20. The method of claim 19 wherein the computer-readable medium is part of a game application including three-dimensional graphics that are displayable in a two-dimensional space.
